(19) United States
(12) Patent Application Publication
(10) Pub. No.: US 2014/0351806 A1
(43) Pub. Date: Nov. 27, 2014

(54) SYSTEMS, METHODS, AND COMPUTER PROGRAM PRODUCTS FOR MANAGING SERVICE UPGRADES

(71) Applicant: JVL VENTURES, LLC, New York, NY (US)

(72) Inventor: Michael J. Gargiulo, Corinth, TX (US)

(73) Assignee: JVL VENTURES, LLC, New York, NY (US)

(21) Appl. No.: 14/278,153

(22) Filed: May 15, 2014

Related U.S. Application Data
(60) Provisional application No. 61/825,861, filed on May 21, 2013.

(51) Int. Cl. G06F 9/445; G06F 21/10; G06F 9/44

(52) U.S. Cl. CPC G06F 8/65; G06F 8/71; G06F 21/10
USPC 717/170

(57) ABSTRACT

System, methods, and computer program products are provided for managing service upgrades. A service upgrade procedure upgrades a service from a first version of the service installed on a secure element to a second version of the service. Thus, applets may be comprehensively managed post-issuance. User experience is improved.

### CROSS REFERENCE TO RELATED APPLICATION

This application claims priority to U.S. Provisional Application No. 61/825,861, filed May 21, 2013, the contents of which are incorporated herein by reference.

### BACKGROUND

1. Field

The present invention relates to mobile devices equipped with services, and more particularly to systems, methods, and computer program products for managing service upgrades.

2. Related Art

A service provider (SP) is a company, organization, entity, or the like, that provides services to customers or consumers. Examples of service providers include account-issuing entities such as merchants, card associations, banks, marketing companies, and transit authorities. A service may be an activity, capability, functionality, work, or use that is permitted or provided by a service provider such as a payment service, a ticketing service, a gift, offer or loyalty service, a transit pass service, and the like. A service may be used via a mobile device, for example, by utilizing one or more applets that make up that service.

In a mobile environment that involves contactless transactions involving mobile devices and service providers, information relating to the accounts and applets issued by the service providers is downloaded onto mobile devices in order to enable them to perform the contactless transactions.

A trusted service manager (TSM) is typically an independent entity serving mobile network operators (MNOs) and account-issuing service providers, for example, by provisioning applets, such as contactless applets associated with the service providers, to mobile devices. Typical TSMs can distribute and manage the contactless applets remotely because they have access to secure elements (SEs) in a near field communication (NFC) enabled mobile device.

A secure element is a platform onto which applets can be installed, upgraded, and managed. It consists of hardware, software, interfaces, and protocols that enable the secure storage of data such as credentials, and execution of applets for payment, authentication, and other services. An applet or set of applets may correspond to a service (e.g., payment, commerce, ticketing) offered by a service provider.

The secure element may be implemented in different form factors such as a Universal Integrated Circuit Card (UICC), an embedded secure element, or NFC enablers such as a separate chip or secure device, which can be inserted into a slot on the mobile device. Typically a UICC is in the form of a subscriber identity module (SIM), which is controlled by the MNOs. An embedded secure element gives service providers the option to embed the secure element into the phone itself. One way in which secure element form factors are implemented is defined in, for example, GlobalPlatform Card Specification Versions 2.1.1, 2.2, and 2.2.1 (hereinafter “Global Platform”). A secure element may also be implemented outside of the mobile device with which it may be associated with. For example, such a secure element may be implemented in cloud-based, remote, or virtual storage.

A secure element may include one or more security domains (SDs), each of which includes a collection of data, such as packages, applets, and the like, that trust a common entity (e.g., are authenticated or managed by using a common security key or token).

Security domains may be associated with service providers and may include service provider applets such as loyalty, couponing, credit card, and transit applets.

A central TSM is a system for interfacing (e.g., communicating, beginning a dialog) service providers and secure elements, for example for service providers to upgrade services on a secure element, transmit scripts to be processed, and the like. An exemplary embodiment of a central TSM for managing communications between service providers and secure elements is described in more detail in U.S. patent application Ser. No. 13/653,160 entitled “Systems, Methods, and Computer Program Products for Interfacing Multiple Service Provider Trusted Service Managers and Secure Elements,” which is hereby incorporated by reference in its entirety.

An enterprise service bus (ESB) is an architecture model for implementing the interactions and communications between entities (e.g., secure elements, SP TSMs, central TSM).

Traditionally, after a first version of a service is deployed on a secure element, and a second (e.g., upgraded) version of the service is available, an end-user or customer of the service would have to manually perform multiple operations (e.g., manual deletion, manual installation) for upgrading services already deployed on the secure element.

Periodically, for instance, services on the secure element require changes to correct software errors, to add new functionality, and/or to enhance operability. Manual deletion of the first version of the service and manual installation of the second version of the service is sometimes required. Generally, users do not wish to be involved with such upgrades.

That is, traditionally the end-user or customer of the service executes several manual steps that require user interaction and knowledge of an applet and/or internal implementation of the applet to perform the upgrade. This is a time consuming procedure, which requires user coordination and reliance, thereby increasing the likelihood of errors.

One technical challenge involves centralizing and automating a process to upgrade a first version of a service deployed on a mobile device to a second version, without the need for manual end-user or customer input.

### BRIEF DESCRIPTION

The present invention provides systems, methods, and computer program products for managing service upgrades.

In one embodiment, a system for managing service upgrades includes a processor coupled to a memory. The processor (e.g., included in a central trusted service manager, central TSM) receives, over a communications network (e.g., from an ESB, or a service provider trusted service manager, SP TSM), an upgrade request to upgrade a service from a first version of the service installed on a secure element to a second version of the service, and a determination is made whether to install the second version of the service on the secure element. The second version of the service is installed on the secure element and activated (e.g., made usable or selectable) if it is determined that the second version of the service is to be installed.

In another embodiment, a method for managing service upgrades includes receiving, over a network, an upgrade request to upgrade a service from a first version of the service installed on a secure element to a second version of the service, and determining whether to install the second version of the service on the secure element. The second version of the service is installed on the secure element and activated if it is determined that the second version of the service is to be installed.

In another embodiment, a non-transitory computer-readable medium having stored thereon sequences of instructions, the sequences of instructions including instructions, which, when executed by a computer system cause the computer to: receive, over a network, an upgrade request to upgrade a service from a first version of the service installed on a secure element to a second version of the service; determine whether to install the second version of the service on the secure element; and install and activate the second version of the service on the secure element if it is determined that the second version of the service is to be installed on the secure element.

### BRIEF DESCRIPTION OF THE DRAWINGS

The features and advantages of the present invention will become more apparent from the detailed description set forth below when taken in conjunction with the following drawings.

FIG. 1 is a diagram of a system for interfacing between service providers and mobile devices having secure elements according to an exemplary embodiment.

FIG. 2 is a sequence diagram illustrating a sequence for managing a service upgrade request according to an exemplary embodiment.

FIG. 3 is a flowchart illustrating a sequence for managing upgrading of a shared service according to an exemplary embodiment.

FIG. 4 is a flowchart illustrating a sequence of processing states of a service during upgrading of a service according to an exemplary embodiment.

FIG. 5 is a flowchart illustrating a counter reset policy of the upgrading procedure according to an exemplary embodiment.

FIG. 6 is a block diagram of an exemplary system useful for implementing the present invention.

### DETAILED DESCRIPTION

Overview

The example embodiments presented herein describe mobile devices equipped with services, and more particularly, systems, methods, and computer program products for managing service upgrades. This is for convenience only, and is not intended to limit the application of the present invention. In fact, after reading the following description, it will be apparent to one skilled in the relevant art(s) how to implement the following invention in alternative embodiments, such as in other system components (e.g., an ESB, SP TSM) capable of managing a service upgrade request sent over a network to upgrade a service deployed on any device including a mobile device or secure element implemented in any manner (e.g., UICC, cloud-based).

Generally, a system such as an enterprise service bus (ESB), communicating with a central TSM can be used to upgrade a service (e.g., an applet, multiple applets, or any other information to be associated with a service), already deployed on the secure element.

The terms “applet,” “application,” and/or the plural form of these terms are used interchangeably herein to refer to an applet (functioning independently or in conjunction with other applets) or set or subset of instructions or code, which when executed by one or more processors (e.g., in a mobile device, card reader, terminal, point of sale (POS) system, or server) causes the processor(s) to perform specific tasks. It should be understood that “applets” as used herein refers to generic or instances of applets on a secure element.

In one exemplary embodiment, the ESB may transmit a request to the central TSM to upgrade a service on a secure element. In response, the central TSM executes several steps, including, among other steps, checking parameters included in the request (e.g., secure element identifier, service identifier, service qualifier, force upgrade parameter), updating a processing state of a service, deleting a service instance(s), deleting a service package(s), installing a service package(s), and installing and/or instantiating a service instance(s) using the package(s).

Installing and/or instantiating a service on a secure element are described in more detail in U.S. patent application Ser. No. 13/653,145 entitled “Systems, Methods, and Computer Program Products For Managing Secure Elements,” which is hereby incorporated by reference in its entirety. Generally, service instantiation includes creating an instance of an applet on a secure element and extraditing that instance to a security domain on a secure element.

That is, the central TSM is able to manage the service upgrade request (e.g., from service providers) to upgrade a service on a secure element without the need to rely on intermediary sources such as an end-user or customer input, for example, via a mobile device.

As a result, the processing time required to execute the service upgrade request is minimized relative to, for example, a system requiring input and/or interactions using a mobile device. Moreover, errors and resource overuse can be minimized or eliminated.

System

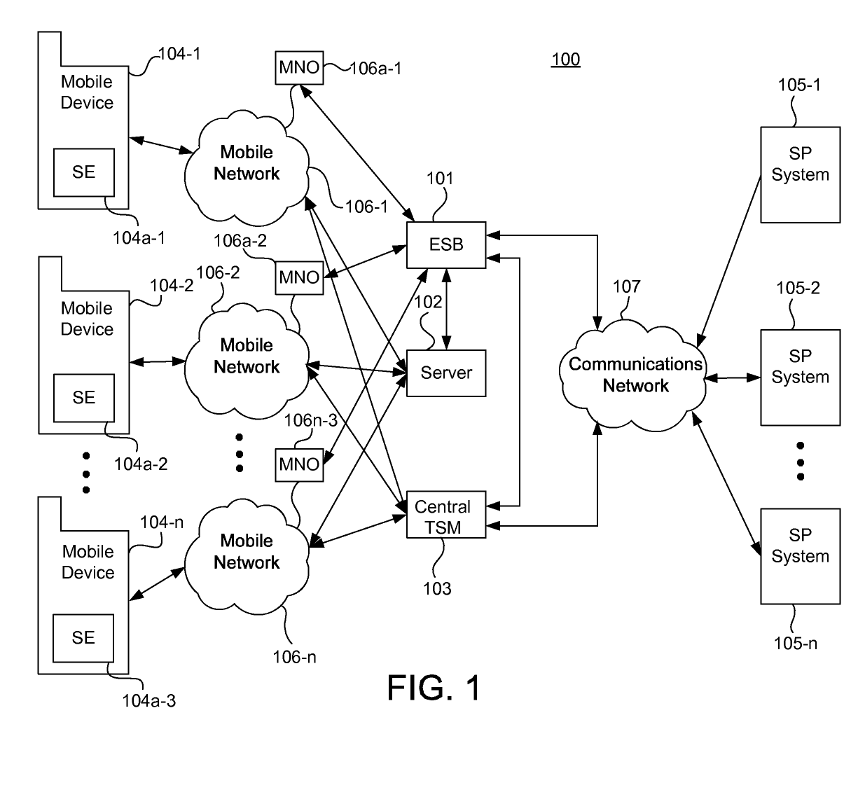

FIG. 1 is a diagram of an exemplary system 100 for interfacing between service providers and mobile devices having secure elements according to an exemplary embodiment. As shown in FIG. 1, system 100 includes an ESB 101, which is communicatively coupled to a server 102 (which may also be referred to as a “wallet server” or “mobile wallet server”) and a central TSM 103.

In the exemplary embodiments described herein, the central TSM 103 includes a processor and a memory (e.g., a database) and handles the installation and upgrading of services on secure elements.

In addition, the ESB 101 is communicatively coupled to SP systems 105-1, 105-2, . . . , 105-n (collectively “105”) via a communications network 107. Communications network 107 may be a virtual private network (VPN), a network using Transmission Control Protocol/Internet Protocol (TCP/IP) standards, or the like.

Generally, the ESB 101 manages interactions between SP systems 105 and mobile devices 104-1, 104-2, . . . , 104-n (collectively “104”), and grants the SP systems the ability to efficiently and securely communicate with the mobile devices 104 in order to, for example, upgrade a service without the need for directly communicating with each of the mobile devices 104.

In an example embodiment, the ESB 101 is hardware and/or software that is implemented to serve as an intermediary between SP systems 105 and mobile devices 104, for example, for processing requests (e.g., to upgrade a service) within a mobile commerce system.

In another example embodiment, the processes and functions described below with reference to an ESB (e.g., ESB 101) can be performed by a central TSM (e.g., central TSM 103).

The server 102 and the central TSM 103 are each communicatively coupled to mobile devices 104 via corresponding mobile networks 106-1, 106-2, . . . , 106-n (collectively “106”). Each of the mobile networks 106 is operated by a corresponding MNO 106a-1, 106a-2, . . . , 106a-n (collectively “106a”).

The server 102 and the central TSM 103 communicate with mobile devices 104 via the mobile networks 106, using security protocols such as Global Platform secure channel protocol, SSL, TLS, or the like. Mobile networks 106 may be mobile phone cellular networks, radio networks, or the like.

Each of the mobile devices 104 includes a corresponding secure element 104a-1, 104a-2, . . . , 104a-n (collectively “104a”), and a corresponding mobile wallet (not shown).

A mobile wallet is an application stored in a non-transitory memory of a mobile device including instructions which, when executed by the processor of a mobile device, cause the mobile device to act as an instrument, for example, for processing contactless transactions or for processing commerce information such as offer or loyalty information. A mobile wallet and a corresponding secure element may communicate using ISO 7816 commands, in order to conduct contactless transactions.

Each of the mobile devices 104 may include a user interface such as a display for receiving inputs from and outputting data to a user.

Process

A. Upgrading a Service on a Secure Element

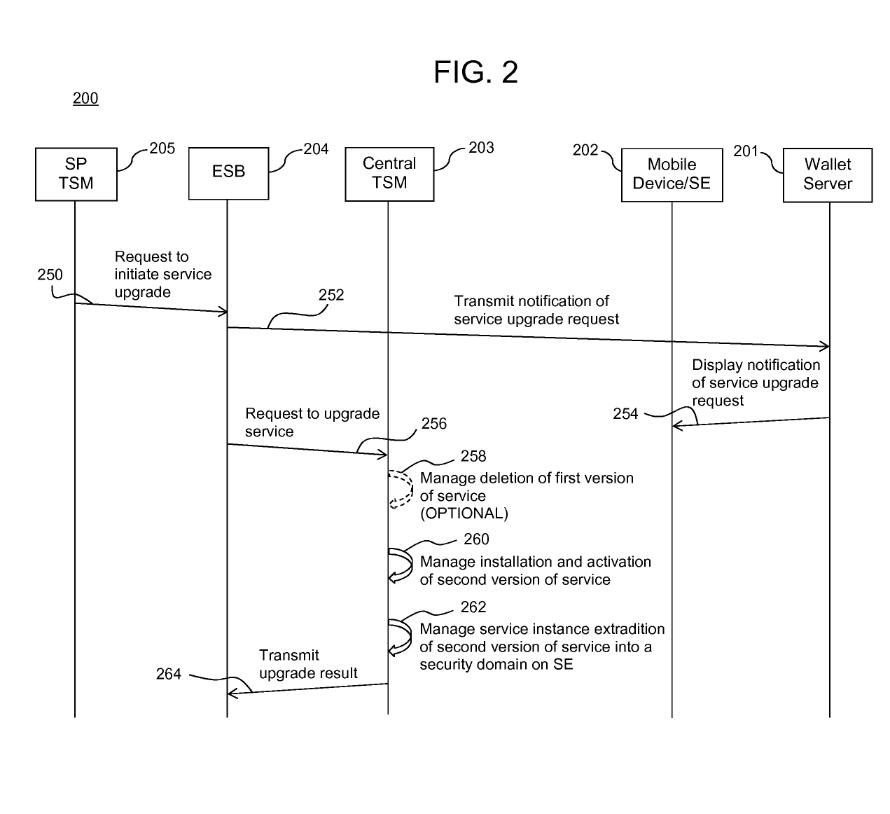

FIG. 2 is a sequence diagram illustrating a sequence for managing a service upgrade, for example, to upgrade a service deployed on a secure element of a mobile device (e.g., FIG. 1, SE 104a-1, mobile device 104-1), from a first version of a service installed on the secure element to a second (e.g., upgraded) version of the service.

In FIG. 2, a service upgrade is to be performed. Because a service upgrade encompasses upgrading a range of services including mobile commerce provider services (e.g., mobile wallet companion applet, WCAp) and service provider services (e.g., credit card issuer applets), the service upgrade may be triggered by various systems.

In one exemplary embodiment, a service upgrade procedure is triggered by an internal determination by a component within a mobile commerce system to upgrade a service (e.g., according to an analysis of certain criteria by a SP system, FIG. 1 at 105-1). Optionally, in another exemplary embodiment, as shown at step 250, a service upgrade procedure is triggered by a request received from an external system (e.g., FIG. 1, SP system 105-1) to upgrade the service, at step 250. The ESB 204 receives the request to initiate the service upgrade, from the mobile commerce provider or the SP TSM (e.g., FIG. 2 at 205), which in turn initiates the service upgrade procedure.

In turn, an event notification is used to notify systems and users regarding an event such as a service upgrade. The event notification includes information identifying the service to be upgraded. For example, the information in the event notification may include a service identifier or account identifier associated with the service.

At step 252, the ESB 204 (e.g., FIG. 1, ESB 101) transmits, over the network, an event notification of a service upgrade to the wallet server 201 (e.g., FIG. 1, Server 102). In turn, the wallet server 201 receives the notification and updates the status of that service in its memory. The wallet server 201 transmits, at step 254, a notification to the mobile device 202 (e.g., FIG. 1, Mobile Device 104-1) indicating that a service on that mobile device is being upgraded. The notification is displayed or otherwise communicated by the mobile device to its user at step 254, for example, via the user interface of the mobile device 202.

Management of event notifications is described in more detail in U.S. patent application Ser. No. 13/848,962 entitled “Systems, Methods, and Computer Program Products for Provisioning Payment Accounts Into Mobile Wallets and Managing Events,” which is hereby incorporated by reference in its entirety. Generally, event notifications are transmitted between systems such as an ESB and a server. Event notification may be used, for example, to communicate information regarding an event, or as in exemplary embodiments described herein, to notify systems and users of a service upgrade.

At step 256, the ESB 204 (e.g., FIG. 1, ESB 101) sends an upgrade request to central TSM 203 (e.g., FIG. 1, central TSM 102) to upgrade the service installed on the secure element of the mobile device, from a first version of the service to a second version of the service.

The upgrade request may include one or more of the following attributes: a secure element identifier, a service identifier, and a service qualifier, which are used to process the upgrade request at step 256. For example, these attributes are used to identify the mobile device, secure element, and/or service which are to be acted on during the service upgrade.

The secure element identifier is a unique number or set of characters that is written to a secure element and is used (e.g., by central TSM 203) to identify the secure element on which the upgrade request is to be performed. For example, the secure element identifier may be a Card Image Number (CIN).

The service identifier may include a service identifier number and version of the service, which are used (e.g., by central TSM 203) to identify a service on SE 202 which is to be upgraded in accordance with the request.

The service qualifier includes information that further qualifies or defines the service. For example, if multiple instances of a service are installed in association with a mobile wallet on a mobile device, the service qualifier may be used to refer to a particular instance of the service. The service qualifier may include a service provider name, an application identifier (AID), and a payment account reference number (PRN), and is used (e.g., by central TSM 203) to identify the particular instance of the service (e.g., the service corresponding to the service identifier) that is to be acted on (e.g., installed, deleted, upgraded) by using requests, for example, by issuing and executing commands on the service.

In an example embodiment, the first version of the service is deleted prior to the second version of the service being installed on the SE 202. As shown in FIG. 2, at step 258, the central TSM 203 (e.g., via an API) manages the deletion of the first version of the service on the SE 202 by transmitting one or more commands to the SE 202. Additionally, if the first version of the service is not shared with other service providers (e.g., if there are no other instances of the service created or instantiated) on the secure element, and the service package is deletable, the central TSM 203 manages, at step 258, a deletion of the service package from the SE 202.

In another example embodiment, the first version of the service is not deleted prior to the second version of the service being installed on the SE 202, thereby allowing for the use of both the first and second versions of the service on the SE 202. That is, the second (e.g., upgraded) version of the service can be installed, appended or modified without requiring step 258 of FIG. 2 to be performed. Instead, the first version of the service may remain installed on the secure element along with the newly- or later-installed second version of the service.

At step 260, central TSM 203 (e.g., via an API) manages installation and activation of the second (e.g., upgraded) version of the service. The installation and activation steps include, for example, creating an instance of (e.g., instantiating) the second version of the service on the SE 202, and making the applets associated with the second version of the service usable or selectable on the SE 202. As described above, the service identifier and service qualifier are used to identify the general and particular instance of the service to be activated (e.g., made usable or selectable) on the secure element.

At step 262, the central TSM 203 extradites the instantiated instance of the second version of the service into a corresponding security domain on the SE 202.

Service deletion, activation, and extradition are described in more detail in U.S. patent application Ser. No. 13/653,145 entitled “Systems, Methods, and Computer Program Products for Managing Secure Elements,” which is hereby incorporated by reference in its entirety. In particular, service deletion, activation and extradition are performed by the central TSM transmitting commands (e.g., by using APDU commands) to a target secure element on a mobile device.

When the service upgrade has been completed, for example, the central TSM 203 has completed steps 258-262 of FIG. 2, including managing the deletion of the first version of the service (optional), managing the installation and activation of the second version of the service, and managing service instance extradition of the second version of the service into a security domain on the secure element, as described above, the central TSM 203, at step 264, transmits a response over the network to the ESB 204. The response, at step 264, includes information indicating the result (e.g., success, failure) of the upgrading requested by the ESB 204 at step 256.

In another example embodiment, service upgrade may also include performing a technical eligibility check (e.g., TSM eligibility check) or a business eligibility check (e.g., MNO eligibility check). Exemplary technical eligibility checks and business eligibility checks are described in more detail in U.S. patent application Ser. No. 13/848,962 entitled “Systems, Methods, and Computer Program Products for Provisioning Payment Accounts into Mobile Wallets and Managing Events,” which is hereby incorporated by reference in its entirety. For example, a technical eligibility check may be used to determine whether SE 202 has sufficient memory space to have both the first version of the service and the second version of the service installed on it. A business eligibility check may include validating a mobile directory number associated with a secure element identified in the service upgrade request.

B. Managing Upgrading of a Shared Service

As described in FIG. 2, above, the central TSM 203 (e.g., FIG. 1, central TSM 103) manages the upgrading of services on mobile devices and/or secure elements. The central TSM 203 is also equipped to determine whether or not to upgrade a service that is shared between multiple service providers. A service is deemed to be shared when two instances of that service are installed on a secure element 202 (e.g., FIG. 1, SE 104a-1).

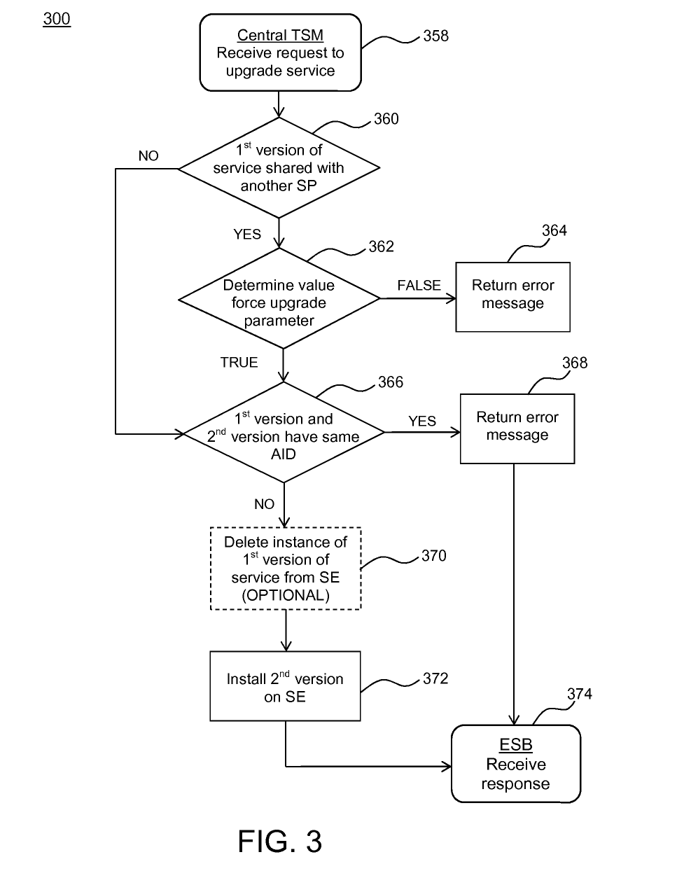

FIG. 3 is a flowchart illustrating a sequence for determining whether or not to upgrade a service from a first version to a second version, based on whether or not multiple instances of the first version exist on the secure element 202.

Referring to both FIGS. 2 and 3, at step 358, central TSM 203 receives an upgrade request to upgrade a service, for example, from a first version of a service installed on a secure element to a second version of the service. As described above, the upgrade request may include a number of attributes, for example, to identify the secure element and service to be acted on during the upgrade process. The upgrade request may also or alternatively include a “force upgrade” parameter, which may be a flag or value set to true or false to indicate how an upgrade request is to be handled in the event that the service is shared with another service provider (e.g., multiple instances of that service are installed on the secure element).

At step 360, the central TSM 203 determines whether the first version of the service is shared with another service provider. This is done by checking whether more than one service on the secure element 202 have the same application identifier (AID).

If it is determined, at step 360, that the first version of the service is shared with another service provider, the central TSM 203, in turn, determines the value of the force upgrade parameter at step 362. If the value of the force upgrade parameter is FALSE, an error message is returned to the ESB 204 (e.g., “condition of use not satisfied”), at step 364, and the second version of the service is not installed on the secure element 202. The error message may indicate that the service cannot be upgraded because that service is being shared with another service provider on the secure element 202.

On the other hand, if the value of the force upgrade parameter is determined, at step 362, to be TRUE, the process proceeds to step 366, where a determination is made as to whether the first version of the service and the second version of the service share the same AID (e.g., whether the first version of the service is the same as the second version of the service).

If the central TSM 203 determines at step 366 that the first version of the service and the second version of the service share the same AID, the second version of the service is not installed and an error message is returned at step 368, indicating that the first version of the service and the second version of the service cannot be simultaneously installed on the secure element. That is, in such a case, the second version of the service is not an upgraded version of the first service (because they are the same), and therefore, unnecessary processing of the upgrade request is prevented. In turn, an upgrade service response is sent by the central TSM 203 to the ESB 204, at step 374, indicating, for example, whether the upgrade was a success or a failure.

If the central TSM determines at step 366 that the first version of the service and the second version of the service do not have the same AID (e.g., they are not the same), the central TSM 203 proceeds with the upgrade of the service at steps 370-372. That is, if the first version of the service and the second version of the service do not have the same AID, it is feasible to have both versions of the service installed on the secure element 202.

In particular, optionally, at step 370, the central TSM 203 deletes or manages the deletion of an instance of the first version of the service from the SE 202.

At step 372, the second version of the service is installed on the SE 202, including, for example, installing new service package(s), and installing and/or instantiating service instance(s) using the package(s), which are described above in further detail with relation to FIG. 2. At step 374, an upgrade service response indicating, for example, an upgrade success or failure, is transmitted to the ESB 204.

C. Processing States of the Service in the Central TSM During a Service Upgrade

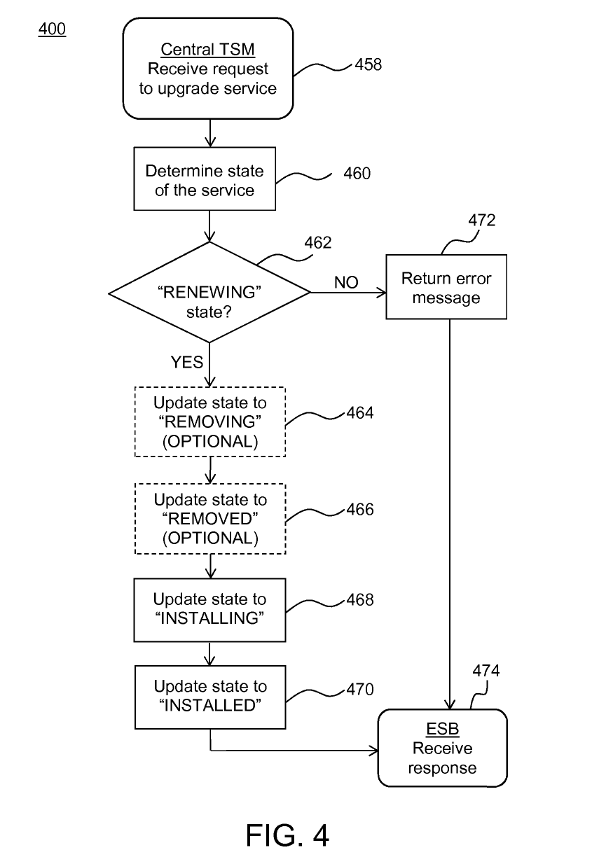

FIG. 4 is a flowchart illustrating a sequence of processing states of a service in the central TSM during the upgrading of a service according to an exemplary embodiment.

Exemplary, states of the service include: “RENEWING,” “REMOVING,” “REMOVED,” “INSTALLING,” and “INSTALLED.”

Referring to both FIGS. 2 and 4, the states are managed and monitored by central TSM 203 during the upgrade procedure. In particular, management of a state includes the central TSM 203 storing in its memory a state corresponding to a service being upgraded on the SE 202 by the central TSM 203.

At block 458 a central TSM 203 receives, from an ESB 204, a request to upgrade a service on SE 202. Upon receiving the request, at block 460, the central TSM 203 determines the state of the service to be upgraded. The state of the service is “RENEWING” when the central TSM 203 is performing upgrading of the service.

A service is in “RENEWING” state when a value of a force upgrade parameter is determined to be true in a case where the first version of the service is shared with another SP, and when the second version of the service does not share the same AID as the first version of the service. The “RENEWING” state indicates that an upgrade procedure has been initiated.

If central TSM 203 determines at block 462 that the state of the service is “RENEWING,” the central TSM 203 updates the state of the service to “REMOVING,” at block 464, during the service deletion step 258 and updates the state of the service to “REMOVED,” at block 466, when the deletion step is completed.

If central TSM 203 determines, at block 462, that the service state is “RENEWING,” the central TSM 203 implements the upgrade request, at step 256. In turn, the central TSM 203 updates the state of the service to “INSTALLING,” at block 468, to indicate that the service is being upgraded.

If central TSM 203 determines that the service state is other than “RENEWING,” at block 462, an error message (e.g., “condition of use not satisfied”) is returned by central TSM 203 to SP TSM 205, at block 472.

Upon completion of service upgrade and activation, the state of the service is updated to “INSTALLED,” at block 470, to indicate that the upgrade procedure is complete.

Central TSM 203 transmits a response, over the network, to ESB 204, at block 474, including a result of processing the upgrade request (e.g., upgrade success or failure).

D. Counter Reset Policy

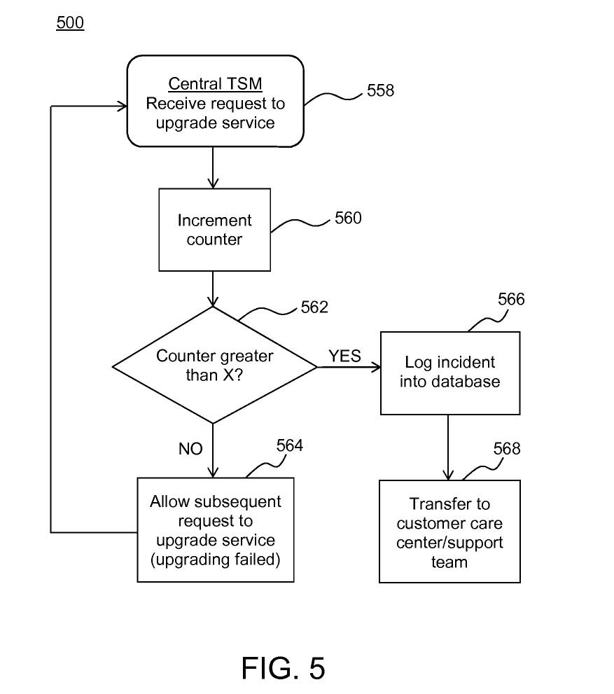

FIG. 5 is a flowchart illustrating a counter reset policy of the upgrade procedure according to an exemplary embodiment.

As shown in FIG. 5, a counter (e.g., Global Platform Secure Channel Protocol ‘02’ (SCP02) counter) counts a number of upgrade requests from the network. The counter is included in central TSM 203 of FIG. 2. Referring to both FIGS. 2 and 5, when central TSM 203 receives an upgrade request, at step 256 of FIG. 2 or block 558 of FIG. 4, to upgrade a service on a secure element, the counter is incremented, at block 560.

To avoid infinite loops, central TSM 203 implements a counter reset policy, at block 562, such that the number of upgrade requests is limited to a predetermined number (e.g., three) of upgrade attempts. That predetermined number is shown as variable “X” in block 562.

Subsequent attempts (e.g., upgrade requests) received by central TSM 203 from SP TSM 205 to upgrade a service are allowed up until the maximum number of upgrade requests has been reached, at block 564. After a last allowed unsuccessful upgrade attempt, further attempts are prohibited by the central TSM 203. The incident (e.g., that the service was unsuccessfully attempted to be upgraded the maximum number of times) may be logged into a database in central TSM 203 and an investigation is initiated, at block 566. A message may be communicated to a mobile device containing the SE 202, which in turn is displayed or otherwise communicated through the mobile device and ultimately to a user of the mobile device through a user interface such as a display or through an audio system. The mobile device can then be used to route the user to a customer care center associated with the central TSM 203 at block 568, where a customer representative may assist in troubleshooting the error.

E. Example Computer-Readable Implementation

The example embodiments described above such as, for example, the systems and procedures depicted in or discussed in connection with FIGS. 1-5 or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

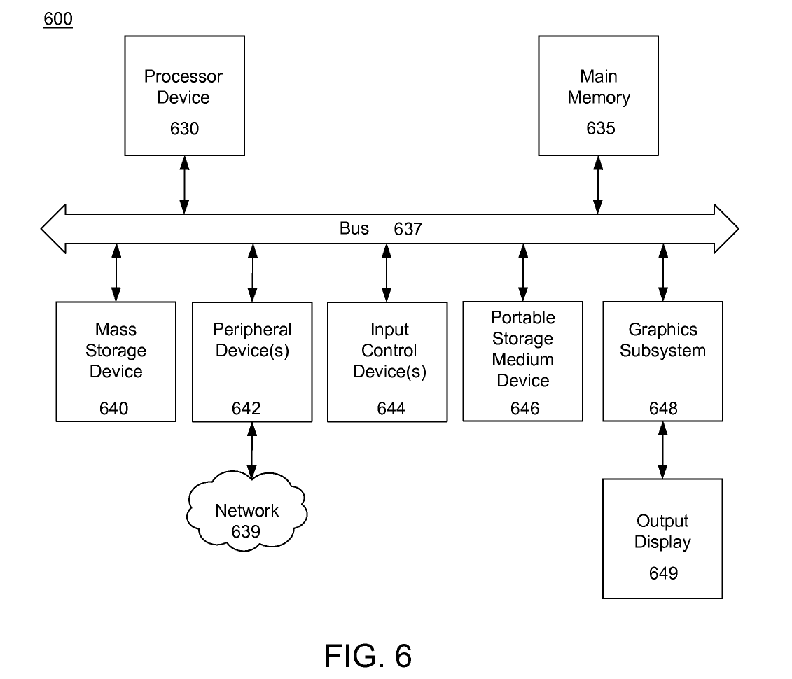

FIG. 6 is a block diagram of a general and/or special purpose computer 600, in accordance with some of the example embodiments of the invention. The computer 600 may be, for example, a user device, a user computer, a client computer and/or a server computer, among other things.

The computer 600 may include without limitation a processor device 630, a main memory 635, and an interconnect bus 637. The processor device 630 may include without limitation a single microprocessor, or may include a plurality of microprocessors for configuring the computer 600 as a multi-processor system. The main memory 635 stores, among other things, instructions and/or data for execution by the processor device 630. The main memory 635 may include banks of dynamic random access memory (DRAM), as well as cache memory.

The computer 600 may further include a mass storage device 640, peripheral device(s) 642, portable storage medium device(s) 646, input control device(s) 644, a graphics subsystem 648, and/or an output display 649. For explanatory purposes, all components in the computer 600 are shown in FIG. 6 as being coupled via the bus 637. However, the computer 600 is not so limited. Devices of the computer 600 may be coupled via one or more data transport means. For example, the processor device 630 and/or the main memory 635 may be coupled via a local microprocessor bus. The mass storage device, 640, peripheral device(s) 642, portable storage medium device(s) 646, and/or graphics subsystem 648 may be coupled via one or more input/output (I/O) buses. The mass storage device 640 may be a nonvolatile storage device for storing data and/or instructions for use by the processor device 630. The mass storage device 640 may be implemented, for example, with a magnetic disk drive or an optical disk drive. In a software embodiment, the mass storage device 640 is configured for loading contents of the mass storage device 640 into the main memory 635.

The portable storage medium device 646 operates in conjunction with a nonvolatile portable storage medium, such as, for example, a compact disc read only memory (CD-ROM), to input and output data and code to and from the computer 600. In some embodiments, the software for storing an internal identifier in metadata may be stored on a portable storage medium, and may be inputted into the computer 600 via the portable storage medium device 646. The peripheral device(s) 642 may include any type of computer support device, such as, for example, an input/output (I/O) interface configured to add additional functionality to the computer 600. For example, the peripheral device(s) 642 may include a network interface card for interfacing the computer 600 with a network 639.

The input control device(s) 644 provide a portion of the user interface for a user of the computer 600. The input control device(s) 644 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 600 may include the graphics subsystem 648 and the output display 649. The output display 649 may include a cathode ray tube (CRT) display and/or a liquid crystal display (LCD). The graphics subsystem 648 receives textual and graphical information, and processes the information for output to the output display 649.

Each component of the computer 600 may represent a broad category of a computer component of a general and/or special purpose computer. Components of the computer 600 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures. Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for managing a service upgrade, the system comprising:
a processor coupled to a memory, the processor being operable to:
receive, over a network, an upgrade request to upgrade a service from a first version of the service installed on a secure element to a second version of the service; and
determine whether to install the second version of the service on the secure element,
wherein if it is determined that the second version of the service is to be installed on the secure element, the processor is further operable to:
install the second version of the service on the secure element; and
activate the second version of the service on the secure element.

2. The system of claim 1, the processor being further operable to extradite the second version of the service into a security domain on the secure element.

3. The system of claim 1, the processor being further operable to delete the first version of the service from the secure element.

4. The system of claim 1, wherein the upgrade request includes a secure element identifier, a service identifier, service qualifier, and a force upgrade parameter.

5. The system of claim 1, wherein during the determining whether to install the second version of the service on the secure element, the processor is further operable to:
determine, upon receiving the upgrade request, if the first version of the service on the secure element is shared between two or more service providers; and
determine, based on a value of the force upgrade parameter included in the upgrade request, whether or not to install the second version of the service on the secure element,
wherein, if the value of the force upgrade parameter is true, the second version of the service is installed on the secure element, and
wherein if the value of the force upgrade parameter if false, the second version of the service is not installed on the secure element and an error notification is transmitted over the network.

6. The system of claim 1,
the memory being operable to store a state of the service, and
the processor being further operable to:
determine the state of the service; and
update the state of the service.

7. The system of claim 1, the processor being further operable to transmit a response over the network including a result of processing the upgrade request.

8. The system of claim 1, the processor being further operable to count a number of upgrade requests received for the service, wherein the number of upgrade requests is limited to a predetermined number.

9. A method for managing a service upgrade, the method comprising:
receiving, over a network, an upgrade request to upgrade a service from a first version of the service installed on a secure element to a second version of the service; and
determining whether to install the second version of the service on the secure element,
wherein if it is determined in the determining step that the second version of the service is to be installed on the secure element,
installing the second version of the service on the secure element; and
activating the second version of the service on the secure element.

10. The method of claim 9, further comprising a step of extraditing the second version of the service into a security domain on the secure element.

11. The method of claim 9, further comprising a step of deleting the first version of the service from the secure element.

12. The method of claim 9, wherein the upgrade request includes a secure element identifier, a service identifier, service qualifier, and a force upgrade parameter.

13. The method of claim 9, wherein the determining step further comprises steps of:
determining, upon receiving the upgrade request, if the first version of the service on the secure element is shared between two or more service providers; and
determining, based on a value of the force upgrade parameter included in the upgrade request, whether or not to install the second version of the service on the secure element,
wherein, if the value of the force upgrade parameter is true, the second version of the service is installed on the secure element, and
wherein if the value of the force upgrade parameter if false, the second version of the service is not installed on the secure element and an error notification is transmitted over the network.

14. The method of claim 9, further comprising steps of:
determining the state of the service; and
updating the state of the service.

15. The method of claim 9, further comprising a step of transmitting a response over the network including a result of processing the upgrade request.

16. The method of claim 9, further comprising a step of counting a number of upgrade requests received for the service, wherein the number of upgrade requests is limited to a predetermined number.

17. A non-transitory computer-readable medium having stored thereon sequences of instructions, the sequences of instructions including instructions, which, when executed by a computer, cause the computer to:
receive, over a network, an upgrade request to upgrade a service from a first version of the service installed on a secure element to a second version of the service; and
determine whether to install the second version of the service on the secure element,
wherein if it is determined that the second version of the service is to be installed on the secure element,
install the second version of the service on the secure element; and
activate the second version of the service on the secure element.

18. The computer-readable medium of claim 17, the sequence of instructions further includes instructions which, when executed by the computer, cause the computer to extradite the second version of the service into a security domain on the secure element.

19. The computer-readable medium of claim 17, the sequence of instructions further includes instructions which, when executed by the computer, cause the computer to delete the first version of the service from the secure element.

20. The computer-readable medium of claim 17, wherein the upgrade request includes a secure element identifier, a service identifier, service qualifier, and a force upgrade parameter.

21. The computer-readable medium of claim 17, wherein during the determining whether to install the second version of the service on the secure element, the sequence of instructions further includes instructions which, when executed by the computer, cause the computer to:
determine, upon receiving the upgrade request, if the first version of the service on the secure element is shared between two or more service providers; and
determine, based on a value of the force upgrade parameter included in the upgrade request, whether or not to install the second version of the service on the secure element,
wherein, if the value of the force upgrade parameter is true, the second version of the service is installed on the secure element, and
wherein if the value of the force upgrade parameter if false, the second version of the service is not installed on the secure element and an error notification is transmitted over the network.

22. The computer-readable medium of claim 17, the sequence of instructions further includes instructions which, when executed by the computer, cause the computer to:
determine the state of the service; and
update the state of the service.

23. The computer-readable medium of claim 17, the sequence of instructions further includes instructions which, when executed by the computer, cause the computer to transmit a response over the network including a result of processing the upgrade request.

24. The computer-readable medium of claim 17, the sequence of instructions further includes instructions which, when executed by the computer, cause the computer to count a number of upgrade requests received for the service, wherein the number of upgrade requests is limited to a predetermined number.
